(19) United States
(12) Patent Application Publication
(10) Pub. No.: US 2014/0269557 A1
(43) Pub. Date: Sep. 18, 2014

(54) VERIFIED EMERGENCY GROUP COMMUNICATIONS

(71) Applicant: Mobilesphere Holdings II LLC, Kirkland, WA (US)

(72) Inventor: Robert G. Mechaley, Jr., Kirkland, WA (US)

(73) Assignee: Mobilesphere Holdings II LLC, Kirkland, WA (US)

(21) Appl. No.: 14/205,845

(22) Filed: Mar. 12, 2014

Related U.S. Application Data
(60) Provisional application No. 61/782,104, filed on Mar. 14, 2013.

(51) Int. Cl. H04W 76/00

(52) U.S. Cl. CPC H04W 76/007
USPC 370/329

(57) ABSTRACT

Wireless communication devices can be designated for group communication. A communication device, which may be part of the designated communication group, originates an emergency message to the communication group. Upon receipt of the emergency message, each wireless communication device that receives the message generates an alarm to alert the user to the arrival of an emergency message. Upon receipt of the emergency message, the user of each of the communication devices activates a response device to indicate that the emergency message has been received. The message originator receives the confirmation messages to determine that each of the members of the communication group have received the emergency message. If a device has not received the emergency message, transmission may be repeated or messages sent to the other group members to notify them of the failure of the device to respond to the emergency message.

### BACKGROUND OF THE INVENTION

1. Field of the Invention

The present disclosure relates generally to orthogonal frequency division multiplex (OFDM) communications and, more particularly, to a technique for verified group messaging in an OFDM communication system.

2. Description of the Related Art

Orthogonal frequency division multiplex (OFDM) communication systems utilize a large number of closely-spaced subcarriers to transmit data. The input data is divided into a number of parallel data streams, one for each subcarrier. Each subcarrier is then modulated using a conventional modulation scheme, such as phase shift keying (PSK), quadrature amplitude modulation (QAM), or the like. The subcarriers are orthogonal to each other to prevent intercarrier interference. Those skilled in the art will appreciate that OFDM technology has developed into a popular communication technique for wideband wireless communication.

OFDM communication systems may be used in public service sectors, such as police and fire departments. Known techniques, such as those described in U.S. application Ser. No. 12/695,919 filed Jan. 28, 2010, now U.S. Pat. No. 8,095,163, and U.S. application Ser. No. 12/755,215, filed on Apr. 6, 2010, describe techniques for OFDM group communication.

In certain situations, an individual may have a need to transmit an urgent message, or an emergency message via the OFDM communication system. It can be appreciated that there is a significant need for techniques that will permit such emergency messaging and a confirmation that other members of a communications group have received the emergency message. The present disclosure provides this, and other advantages, as will be apparent from the following detailed description and accompanying figures.

### BRIEF DESCRIPTION OF THE SEVERAL VIEWS OF THE DRAWING(S)

FIG. 1 illustrates an exemplary communication architecture used to implement a communication network in accordance with the present teachings.

FIG. 2 illustrates frequency allocation in an orthogonal frequency division multiplexed system.

FIG. 3 is a functional block diagram of a wireless communication device constructed in accordance with the present teachings.

FIG. 4 is a flowchart illustrating the operation of the system of FIGS. 1 and 2.

### DETAILED DESCRIPTION OF THE INVENTION

As we will be describing in greater detail below, the present disclosure provides a technique for sending a emergency message and listening for a confirmation of the received message from wireless communication devices that are part of a communication group. The system tracks which wireless communication devices have not sent a confirmation and resends the message. In one embodiment, a supplementary message can be sent to a communication group to identify one or more wireless communication devices that have failed to send a confirmation.

During a call setup process, a set of tones or groups of tones (i.e., sub-carrier channels) are assigned to a particular wireless communication device. The assignment of tones to a particular wireless communication device during a channel set up operation and the actual communication process between a wireless communication device and base station is well known in the art and need not be described in greater detail herein. In accordance with the present teachings, a special tone or set of tones is allocated on the downlink for emergency message communication. The emergency message is sent to a group of wireless communication devices. Each of the group members are provided with means to confirm receipt of the emergency message.

The communication techniques are implemented by a system 100 illustrated in FIG. 1. A base station 102 communicates with a plurality of wireless communication devices 108-114 via wireless communication links 118-124, respectively. Thus, the wireless communication devices 108-114 are all within the coverage area of the base station 102. The wireless communication device 114 is also within the coverage area of a base station 104. The wireless communication device 114 can communicate with the base station 104 via a wireless communication link 126. Also illustrated in FIG. 1 is a wireless communication device 116, which communicates with the base station 104 via a wireless communication link 128. The process of assigning OFDM tones or groups of tones to each of the wireless devices (e.g., the wireless communication device 108) and the actual communication between the wireless communication devices 108-114 and the base station 102 is well-known in the art and need not be described in greater detail herein.

The base station 102 is communicatively coupled to a base station controller 130 via a communication link 132. In a typical embodiment, the base station controller 130 may provide operational control for one or more base stations 102. As illustrated in FIG. 1, the base station 104 is also coupled to the base station controller 130 via a communication link 129. Those skilled in the art will appreciate that a typical wireless communication network will have a large number of base stations that each communicate with a large number of wireless devices. For the sake of clarity, only two base stations (i.e., the base stations 102 and 104) and a few wireless communication devices (i.e., the wireless communication devices 108-116) are illustrated in FIG. 1.

In turn, the base station controller 130 is coupled to a mobile switching center (MSC) 134 via a communication link 136. As is known in the art, the MSC 134 is typically coupled to a large number of base station controllers and is responsible for switching and routing of calls to other base stations and/or a telephone network, such as the public switched telephone network (PSTN) 138.

The MSC 134 may also provide access to a core network 140 via a communication link 142. The core network 140 is the central part of a communication network that may include a number of functions, such as authorization, billing and the like. In addition, the network 140 may provide access to other networks, such as the Internet, for web applications via one or more gateways (not shown).

The MSC 134 is commonly used in circuit-switched networks. For packet-switched networks, a set of equivalent functions may be provided based on TCP/IP and VoIP technologies. The specific form of network elements may vary based on implementation details. However, those skilled in the art will understand that the OFDM implementation of the present teachings may be applicable to a variety of network architectures.

FIG. 1 is simplified to illustrate the operation of the system 100 with a group of wireless communication devices communicating in proximity with each other. In the illustrated embodiment, the wireless communication devices 108-114 are all communicating with the same base station (i.e., the base station 102). However, those skilled in the art will appreciate that the wireless communication devices 108-114 may communicate with other base stations as well. For example, the wireless communication device 114 is capable of communicating with the base station 102 via the wireless communication link 124 or communicating with the base station 104 via the wireless communication link 126. For the sake of simplicity, FIG. 1 also eliminates a number of conventional network elements, such as gateways, firewalls, and other control elements that are not pertinent to a clear understanding of the present teachings.

A plurality of mobile communication devices may be designated for operation in a Group Call function. When individual mobile communication units are designated as part of the same group, the wireless communication devices of that group will all be assigned the same OFDM tones for downlink communications. FIG. 2 illustrates a number of uplink and downlink timeslots and the designation of the tones to various groups. In the example illustrated in FIG. 2, a group of wireless communication devices (e.g., the wireless communication devices 108-110 are designated as Group1. As illustrated in FIG. 2, the wireless communication devices of Group1 are assigned tones 2, 3, and 5 in downlink timeslots 1 and 3. It should be noted that the assigned tones need not be contiguous. Furthermore, the number of tones assigned to a particular group can vary dynamically based on bandwidth requirements for the particular communication application. That is, simple audio communication may require less bandwidth than other forms of data communication, such as streaming video.

Also illustrated in FIG. 2, is a second set of tones assigned to Group2 (e.g., the wireless communication devices 112-116). In this example, the wireless communication devices of Group2 are assigned tones 9 and 10 in downlink time slots 1, 3, 7, 9, and 11. All wireless communication devices that are in a particular sector, cell, or area that identify it as a member of a certain group will receive a Group Call and are assigned the same set of OFDM tones within each timeslot on the downlink (those skilled in the art will appreciate that the downlink is conventionally considered the communication from the base station 102 to the wireless communication devices). Thus, in the example described herein, the wireless communication devices 108-110, which are assigned to Group 1, will all have the same OFDM tones assigned to each wireless communication device.

The information for each group is encoded in a conventional fashion using the assigned tones. When the base station transmits the encoded information using the assigned tones for a group, all members in that Call Group will receive the information simultaneously. Thus, the techniques may be used to support a push-to-talk system in an OFDM communication network. That is, one wireless communication device in a particular communication group (e.g., Group1) can send a message, such as a voice communication, on an uplink in a conventional manner and all wireless communication devices in the communication group will receive the voice communication at the same time. Simultaneous receipt of messages can be important in emergency communication situations. For example, a SWAT team going into action can rely on every team member receiving instructions at the same time with the communication system described herein.

The concept illustrated herein is shown in FIG. 2 in a very simplified form with a relatively small number of tones assigned to individual ones of the groups (e.g., Group1, Group2, and Group3). However, a typical OFDM signal contains hundreds or thousands of tones. This advantageously allows a large number of Group Calls to be supported simply by directing the wireless communication devices in each group to receive the appropriate tones or sets of tones assigned to that group. Again, FIG. 2 illustrates a simplistic version with only three groups set up with a relatively small number of tones assigned to each group. However, the principles described herein can be extended to a large number of groups.

FIG. 2 also illustrates the use of a one or more emergency (EM) tones in the downlink timeslots. When an emergency message is sent to a wireless communication device (by one of the wireless communication devices in a Group, by a wireless communication device that is not part of the group, or by a non-wireless device) that communication includes data in the assigned EM OFDM tones. The emergency message itself can take any convenient form, such as text, audio, video, and the like. The wireless communication device monitors the EM tones on the downlink. If the emergency message has been received by a wireless communication device, that device can transmit a confirmation response to indicate that the emergency message has been received.

The particular OFDM tones designated for an emergency message can be permanently reserved, periodically assigned, or dynamically assigned prior to an alert message being transmitted to wireless communication devices. The EM OFDM need not be contiguous. In the group messaging described above, all members of a group within a particular cell and/or sector may be assigned the same EM OFDM tones as well as the same OFDM tones for group communication on the downlink. Furthermore, a different set of EM OFDM tones may be assigned to a wireless communication device that is designated as a group member, but which may be communicating with a different cell and/or sector. In the example of FIG. 1, the wireless communication device 116 may be part of Group1 even though it communicates with the base station 104. As a member of the communication Group1 the wireless communication device 116 may be assigned the same OFDM tones for regular communication and the same EM OFDM tones for emergency messaging. Alternatively, the wireless communication device 116 may be assigned different OFDM tones for regular communication, as described above, and may also be assigned different EM OFDM tones for emergency messaging.

In an alternative embodiment, multiple communication groups (e.g., Group1 and Group2) may have different sets of OFDM tones for regular communication but share the same set of EM OFDM tones. In the firefighter example, two different units can receive separate group communications from their respective unit commanders. However, if an emergency communication is necessary, all firefighters receive the same emergency message, regardless of the specific communication group because all the wireless communication devices monitor the same set of EM OFDM tones.

In one embodiment, the EM tones can simply indicate the transmission of an emergency message while the message is transmitted using the assigned group OFDM tones. Alternatively, the set of EM OFDM tones can carry the emergency message itself.

Although the emergency messages described herein are readily applicable to Group communications, the EM OFDM tones can be monitored by any wireless communication device. For example, members of the public could receive a weather alert message (e.g., a tornado warning) by detecting data in the EM OFDM tones. In this embodiment, a communication system could permanently reserve one of more OFDM tones for emergency communication messages.

Within a Group, such as firefighters, emergency messages can be sent to the Group wireless communication devices from another firefighter or from a central command location. Upon detection of an emergency message, the wireless communication device must transmit a confirmation indicator to a controller generating the message to indicate that the emergency message has been received. As discussed in greater detail below, the controller will continue to transmit the emergency message to any wireless communication device that fails to send the confirmation indicator.

FIG. 1 illustrates the wireless communication devices (e.g., the wireless communication devices 108-110) in a group (e.g., Group1) as communicating with a single base station. However, the principles of the present disclosure permit group members to be coupled to different base stations. In the example of the SWAT team described above, the actual team members may communicate with a single base station or with multiple base stations if the operational area for the SWAT team is a large geographical area. In addition, a command post, for example, may be established at some distance from the theater of operations. Thus, it is possible that the command post wireless communication device may be in communication with a different base station. In the example of FIG. 1, the wireless communication device 116 may be part of Group1 even though the wireless communication device 116 communicates with the base station 104. The wireless communication device 116 will receive all communications transmitted to the members of Group1. Those skilled in the art will appreciate that the set of OFDM tones may differ from the base station 102 to the base station 104. That is, the members of Group1 communicating with the base station 102 may be assigned a first set of OFDM tones while the members of Group1 communicating with the second base station may be assigned a second set of OFDM tones that may be the same or different from the first set of OFDM tones. However, the system 100 can identify members of a group communicating with different base stations as members of the same group even though the different base stations may have assigned different set of OFDM tones to the respective wireless communication devices communicating therewith. Similarly, wireless communication devices in a single group may be communicating with the same base station, but with different sectors of that base station. In this fashion, all members of a designated group, whether coupled to the same sector or base station or coupled to different sectors or completely different base stations, can still be configured to simultaneously receive communications from other group members.

FIG. 3 is a functional block diagram of an electronic device, such as the wireless communication devices 108-116 in FIG. 1. The device includes a central processing unit (CPU) 148. Those skilled in the art will appreciate that the CPU 148 may be implemented as a conventional microprocessor, application specific integrated circuit (ASIC), digital signal processor (DSP), programmable gate array (PGA), or the like. The wireless communication device 108 is not limited by the specific form of the CPU 148.

The electronic device in FIG. 3 also contains a memory 150. The memory 150 may store instructions and data to control operation of the CPU 148. The memory 150 may include random access memory, ready-only memory, programmable memory, flash memory, and the like. The electronic device is not limited by any specific form of hardware used to implement the memory 150. The memory 150 may also be integrally formed in whole or in part with the CPU 148.

The electronic device of FIG. 3 also includes conventional components, such as a display 152, keypad or keyboard 154 and audio input device 156. These are conventional components that operate in a known manner and need not be described in greater detail. In many electronic devices, the keyboard 154 is integral with a touch-sensitive display such that individual keys are soft coded into the display 152.

The electronic device of FIG. 3 also includes a transmitter 162 such as may be used by the wireless communication device 108 for normal wireless communication with the base station 102 (see FIG. 1). FIG. 3 also illustrates a receiver 164 that operates in conjunction with the transmitter 162 to communicate with the base station 102. In a typical embodiment, the transmitter 162 and receiver 164 are implemented as an OFDM transceiver 166. The transceiver 166 is connected to an antenna 168. Operation of the transceiver 166 and the antenna 168 is well-known in the art and need not be described in greater detail herein.

The wireless communication device in FIG. 3 also includes an emergency message processor 170, a confirmation circuit 172 to activate the confirmation indicator in the message processor 170, and an alarm 174 to alert the user to the receipt of an emergency message.

The various components illustrated in FIG. 3 are coupled together by a bus system 176. The bus system 176 may include an address bus, data bus, power bus, control bus, and the like. For the sake of convenience, the various busses are illustrated in FIG. 3 as the bus system 176.

The emergency message processor 170 controls the emergency message operation of the electronic device of FIG. 3. Activation of the emergency message processor 170 occurs when an emergency message in the EM OFDM tones is decoded by the receiver 164. The emergency message can be decoded by the CPU 148 in the same manner that the CPU would decode any message received on tones assigned to that particular wireless communication device. However, the emergency message is processed separately from any regular message (e.g., voice communication). Alternatively, the emergency message processor can be configured to detect and decode any signal contained within the EM OFDM tones.

When an emergency message is received, the emergency message processor 170 activates the alarm 174 to notify the user of an emergency message. The specific nature of the alarm 174 may depend on the application. In one embodiment, the alarm 174 can emit an audible alert tone or an audio message to the user indicating the receipt of an emergency message.

Such an implementation may be useful for a firefighter. However, an audible alert message may be unsatisfactory for a SWAT team member where an audible sound may give away the presence or location of the SWAT team member. Alternatively, the alarm 174 may be implemented as an alert light or other visible indicator on the wireless communication device or an operably attached display.

In yet another alternative embodiment, the alarm 174 may be implemented to produce a vibration or other silent indication in the wireless communication device or an operably attached device. Those skilled in the art will appreciate that the alarm 174 may be implemented in multiple modes using a combination of the alarm indicators described above.

In another aspect, any of the wireless communication devices that receives the emergency message must transmit a confirmation to indicate that the emergency message has been received. The confirmation circuit 172 may be a button activated by the user upon receipt of the emergency message. The confirmation circuit 172 may be part of the keyboard 154 or a separate button that is part of the wireless communication device or operably connected thereto. Activation of the confirmation circuit 172 causes the emergency message processor 170 in the device receiving the message to transmit a confirmation indicator to confirm receipt of the emergency message.

The communication device originating the alert message may be one of the wireless communication devices within the designated communication group (e.g., Group1), a separate wireless communication device, such as a wireless communication device at a command post, a fixed communication device, which may be a conventional telephone coupled to the PSTN 138, or a computing device coupled to the network 140 or to the Internet (not shown) and communicating with the base station controller 130 via the network 140.

The emergency message processor 170 functions as the controller in the communication device that originates the emergency message to track responses from those communication devices within the designated communication group to thereby confirm that each of the wireless communication devices has received the emergency message. As discussed above, the confirmation circuit 172 can be activated manually by a user of the wireless communication device receiving the emergency message. The confirmation circuit 172 may be manually activated, such as a button pressed or voice activated, by user operation of the audio input 156. The emergency message processor 170 detects activation of the confirmation circuit 172 and sends a confirmation message that is relayed to the emergency message processor 170 of the originating communication device. Alternatively, a centralized emergency message processor 170 can function as the controller to track emergency messages and the confirmation from each wireless communication device in the designated communication group. For example, the emergency message processor 170 may be implemented within the network 140 or coupled to the Internet (now shown) and communicate with the base station controller 130 via the network 140 or the PSTN 138. No matter where the emergency message processor 170 is positioned, it will track the confirmation messages from each of the wireless communication devices in the designated communication group. Thus, the emergency message processor 170 can confirm reception of the emergency message to the device originating the alert. If no confirmation is received, the emergency message processor 170 will resend the alert message until the message has been received and confirmed by each of the wireless communication devices within the communication group or until some designated retry limit or time expiration period has been reached.

Alternatively, the emergency message processor 170 functioning as the controller can optionally compose and transmit a message to other members of the communication group to indicate that one or more members of the communication group did not acknowledge the receipt of the emergency message. Such message notification may be valuable to identify any group members that are out of communication range or may be in trouble. For example, a fallen firefighter may be unable to activate the confirmation circuit 172. An emergency message to other group members to indicate that confirmation was not received can be useful in locating the individual whose confirmation message was not received.

The operation of the system 100 is illustrated in the flow chart of FIG. 4. At a start 200, a communication group (e.g., Group1) has been established. This includes the assignment of OFDM tones for regular communication as well as designated EM OFDM tones for emergency message communication.

At step 202, a communication device transmits an emergency message using the EM OFDM tones. As previously discussed, the device originating the emergency message can be one of the other wireless devices in the designated communication group (e.g., Group1), a different wireless communication device, such as may be present at an on-site command post, a nonwireless communication device, such as may be present in a centralized command post, a computing device, or the like.

In step 204, each of the wireless communication devices in the designated communication group (e.g., Group1) activates the alarm 174 (see FIG. 3) to alert the user to the receipt of an emergency message. As described above, the alarm 174 may take a number of different forms, alone or in combination, to alert the user. Those skilled in the art will appreciate that a wireless communication device that does not receive the emergency message will not activate the alarm in step 204.

In step 206, each of the wireless communication devices in the communication group (e.g., Group1) that receives the emergency message will transmit an emergency message confirmation. The confirmation process may be initiated by pressing a button, such as the confirmation circuit 172 (see FIG. 3), activating a button on the keypad 154, or providing an audio response using the audio input 156. Thus, the system provides for a number of possible techniques by which the transmission of the emergency message confirmation may be accomplished. In an exemplary embodiment, the emergency message processor 170 in each of the wireless communication devices in the communication group (e.g., Group1) detects operation of the confirmation circuit 172 and transmits the necessary emergency message confirmation in step 206.

In an exemplary embodiment, the emergency message confirmations in step 206 are transmitted to the originator of the emergency communication. Within that device, or in a central location, as described above, the emergency message processor receives and logs each of the emergency message confirmations. In decision 208, the emergency message processor 170 determines whether the emergency message confirmation has been received. If an emergency message confirmation has been received, the result of decision 208 is YES and, in step 210, the emergency message processor 170 marks the message as having been received. The process ends at 212 when all members of the communication group (e.g., Group1) have sent message confirmations.

Returning to decision 208, if one or more of the wireless communication devices in the communication group (e.g., Group1) has not transmitted a message confirmation, or if the message confirmation was not received, the result of decision 208 is NO. In that event, the system moves to decision 214 to determine whether a retry number has been exceeded, or, alternatively, whether a time period has expired. If the retry or time period has not been exceeded, the result of decision 214 is NO. In that event, the system returns to step 202 to retransmit the emergency message. The process of steps 202-208 are repeated until the message confirmation is detected (i.e., the result of decision 208 is YES) or until the retry number (or time period) has been exceeded. In that event, the result of decision 214 is YES. If the result of decision 214 is YES, the system moves to step 216 and, optionally, sends messages to other members of the communication group (e.g., Group1) indicating that one or more of the group members has not responded to the transmission of the emergency message. The process ends at 212.

In an alternative embodiment, the system may also await confirmation of the receipt of the message transmitted in step 216. That is, the device originating the original communication message may also await confirmation of the follow-up message to other members of the communication group indicating that the group members have acknowledged that one or more of the members of the communication group have not received the original emergency message.

For example, a change in conditions at the scene of a fire may require repositioning of firefighters or evacuation of an area. The emergency messages can be transmitted to the selected group of firefighters that are part of the designated communication group (e.g., Group1). In this event, the confirmation messages from each of the members of the communication group advantageously allow the message originator to determine that the emergency message has been received by all members of the communication group.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system for emergency communication in an OFDM communication system, comprising:
a plurality of wireless communication devices, each having:
a receiver configured to receive data from a base station, each of the plurality of wireless communication devices having designated data communication OFDM tones in a downlink timeslot for data communication and a plurality of separate emergency OFDM tones in the downlink timeslot for use in emergency message communications wherein the receiver in each of the plurality of wireless communication devices decodes the designated emergency OFDM tones to thereby detect an incoming emergency message;
a transmitter configured to transmit data to the base station; and
an emergency message processor to control emergency communications, the emergency message processor, when activated, being configured to cause the transmitter to transmit an acknowledgement message to a sender of the emergency message via the base station.

2. The system of claim 1 wherein the emergency message is transmitted from a first one of the plurality of wireless communication devices, the first wireless communication device activating the emergency message processor that, when activated, operates to:
cause the receiver of the first wireless communication device to decode predetermined emergency OFDM tones to detect acknowledgement messages from others of the plurality of wireless communication devices to indicate that the others of the plurality of wireless communication devices have received the emergency message; and
cause the transmitter of the first wireless communication device to continue to transmit the emergency message to any of the others of the plurality of wireless communication devices from whom the acknowledgement message is not received.

3. The system of claim 1 wherein the emergency message is transmitted from a communication device other than one of the plurality of wireless communication devices, the communication device comprising:
an emergency message processor associated with the communication device that, when activated, operates to:
cause the communication device to decode predetermined emergency OFDM tones to detect acknowledgement messages from the plurality of wireless communication devices to indicate that the plurality of wireless communication devices have received the emergency message; and
cause the communication device to continue to transmit the emergency message to any of the plurality of wireless communication devices from whom the acknowledgement message is not received.

4. The system of claim 3, further comprising a public switched telephone network (PSTN) communicatively coupled to the base station wherein the emergency message is transmitted from a communication device coupled to the PSTN.

5. The system of claim 1, further comprising a confirmation circuit in each of the plurality of wireless communication devices wherein activation of the confirmation circuit in the others of the plurality of wireless communication devices that received the emergency message causes the emergency message processor in the others of the plurality of wireless communication devices that received the emergency message to transmit the acknowledgement message, using the respective transmitters, to thereby indicate that the others of the plurality of wireless communication devices have received the emergency message.

6. The system of claim 5 wherein the confirmation circuit comprises a user-operable button separate from a keyboard.

7. The system of claim 1 wherein the emergency message processor associated with the sender of the emergency message is configured to:
receive the acknowledgement messages from the others of the plurality of wireless communication devices that received the emergency message, the acknowledgment message including data identifying the individual ones of the others of the plurality of wireless communication devices that received the emergency message; and
to send a message to the others of the plurality of wireless communication devices that received the emergency message to identify any of the others of the plurality of wireless communication devices from whom the acknowledgement message is not received.

8. The system of claim 1, further comprising an audible alarm in each of the plurality of wireless communication devices that is activated in response to the receipt of the emergency message.

9. The system of claim 1 wherein each of the plurality of wireless communication devices is assigned the same set of designated data communications OFDM tones for use on the downlink whereby each of the plurality of wireless communication devices receives the same communication data on the downlink as a Group Call function.

10. The system of claim 1 wherein each of the plurality of wireless communication devices is assigned the same set of designated emergency OFDM tones for use on the downlink.

11. A method for emergency communication by a plurality of wireless communication devices in an OFDM communication system with each of the plurality of wireless communication devices having a transmitter and a receiver, the method comprising:
each of the plurality of wireless communication devices having designated data communication OFDM tones in a downlink timeslot for data communication and a plurality of separate emergency OFDM tones in the downlink timeslot for use in emergency message communications wherein the receiver in each of the plurality of wireless communication devices decodes the designated emergency OFDM tones to thereby detect an incoming emergency message; and
upon receipt of the emergency message, each of the plurality of wireless communications devices transmitting an acknowledgement message to a sender of the emergency message.

12. The method of claim 11 wherein the emergency message is transmitted from a first one of the plurality of wireless communication devices, the first wireless communication device activating an emergency mode that, when activated, operates to:
cause the receiver of the first wireless communication device to decode the predetermined emergency OFDM tones to detect acknowledgement messages from others of the plurality of wireless communication devices to indicate that the others of the plurality of wireless communication devices have received the emergency message; and
cause the transmitter of the first wireless communication device to continue to transmit the emergency message to any of the others of the plurality of wireless communication devices from whom the acknowledgement message is not received.

13. The method of claim 11 wherein the emergency message is transmitted from a communication device other than one of the plurality of wireless communication devices, the method further comprising:
decoding the predetermined emergency OFDM tones to detect acknowledgement messages from the plurality of wireless communication devices to indicate that the plurality of wireless communication devices have received the emergency message; and
continuing to transmit the emergency message to any of the plurality of wireless communication devices from whom the acknowledgement message is not received.

14. The method of claim 13, for use with a public switched telephone network (PSTN) wherein the emergency message is transmitted from a communication device coupled to the PSTN.

15. The method of claim 11 for use with a confirmation circuit in each of the plurality of wireless communication devices, the method further comprising:
activating the confirmation circuit in the others of the plurality of wireless communication devices that received the emergency message to thereby cause the others of the plurality of wireless communication devices that received the emergency message to transmit the acknowledgement message, using the respective transmitters, to thereby indicate that the others of the plurality of wireless communication devices have received the emergency message.

16. The method of claim 15 wherein the confirmation circuit comprises a user-operable confirmation button, the method further comprising activating the confirmation button to thereby activate the confirmation circuit.

17. The method of claim 11, further comprising the sender of the emergency message:
receiving the acknowledgement messages from the others of the plurality of wireless communication devices that received the emergency message, the acknowledgment message including data identifying the individual ones of the others of the plurality of wireless communication devices that received the emergency message; and
sending a message to the others of the plurality of wireless communication devices that received the emergency message to identify any of the others of the plurality of wireless communication devices from whom the acknowledgement message is not received.

18. The method of claim 11, further comprising activating an audible alarm in each of the plurality of wireless communication devices in response to the receipt of the emergency message.

19. The method of claim 11 wherein each of the plurality of wireless communication devices is assigned the same set of designated emergency OFDM tones for use on the downlink wherein the receiver in each of the plurality of wireless communication devices decodes the designated emergency OFDM tones at substantially the same time to thereby detect an incoming emergency message.

20. A method for emergency communication by a plurality of wireless communication devices in an OFDM communication system with each of the plurality of wireless communication devices having a transmitter and a receiver, the method comprising:
sensing activation of an emergency activation button in a first of the plurality of wireless communication devices to thereby initiate emergency communications;
transmitting an emergency message from the first wireless communication device to others of the plurality of wireless communication devices, the emergency message including identification data to identify the first wireless communication device;
decoding a set of predetermined emergency OFDM tones to detect an acknowledgement message from others of the plurality of wireless communication devices indicating that others of the plurality of wireless communication devices received the emergency message; and
retransmitting the emergency message to any of the others of the plurality of wireless communication devices from whom the acknowledgement message is not received.

21. The method of claim 20, further comprising:
receiving the acknowledgement messages from the others of the plurality of wireless communication devices that received the emergency message, the acknowledgment message including data identifying the individual ones of the others of the plurality of wireless communication devices that received the emergency message; and
sending a message to the others of the plurality of wireless communication devices that received the emergency message to identify any of the others of the plurality of wireless communication devices from whom the acknowledgement message is not received.

22. The method of claim 20 wherein each of the plurality of wireless communication devices is assigned the same set of designated emergency OFDM tones for use on the downlink wherein the receiver in each of the plurality of wireless communication devices decodes the designated emergency OFDM tones at substantially the same time to thereby detect the emergency message from the first wireless communication device.

23. The method of claim 20 wherein each of the plurality of wireless communication devices is assigned the same set of designated data communications OFDM tones for use on the downlink whereby each of the plurality of wireless communication devices receives the same communication data on the downlink as a Group Call function.

24. The method of claim 23 wherein the emergency message is transmitted to each of the plurality of wireless communication devices using the same set of designated data communications OFDM tones whereby each of the plurality of wireless communication devices receives the same emergency message on the downlink as a Group Call function.
